(19) United States
(12) Patent Application Publication
(10) Pub. No.: US 2026/0235233 A1
(43) Pub. Date: Aug. 13, 2026

(54) REFRIGERANT HOSE AND METHOD OF MANUFACTURING SAME

(71) Applicant: THE YOKOHAMA RUBBER CO., LTD., HIRATSUKA-SHI, KANAGAWA (JP)

(72) Inventor: Tomoki OKA, HIRATSUKA-SHI, KANAGAWA (JP)

(21) Appl. No.: 19/154,060

(22) PCT Filed: Dec. 4, 2023
(86) PCT No.: PCT/JP2023/043264

§ 371 Date: Aug. 6, 2025

(30) Foreign Application Priority Data
Apr. 27, 2023 (JP) 2023-073417

(51) Int. Cl. F16L 11/08; F24F 1/26

(52) U.S. Cl. CPC F16L 11/082; F24F 1/26

(57) ABSTRACT

A refrigerant hose is manufactured by: making different specifications of a fiber cord having an outer diameter of ≥0.4 mm and ≤0.6 mm; vulcanizing samples of hoses molded using the different fiber cord specifications, and tensile testing on each fiber cord removed from the samples at 150° C. to grasp a relationship between a tensile load and elongation and strength at break at room temperature; determining, based on required standard values of elongation under a load of 1.3 cN/dtex at 150° C. and strength at break at room temperature for the reinforcing cord and based on the relationship between a tensile load and elongation grasped and the strength at break at room temperature, a specification of the fiber cord that satisfies each standard value; and molding the hose by using the fiber cord having the specification determined.

### TECHNICAL FIELD

The present invention relates to a refrigerant hose and a method of manufacturing the same and particularly relates to a refrigerant hose for an air conditioner to be installed in a vehicle and a method of manufacturing the same.

### BACKGROUND ART

Various refrigerant hoses through which a refrigerant flows have been proposed (see, for example, Patent Document 1). A refrigerant hose generally has a structure in which an inner layer, a reinforcing layer formed of reinforcing cords, and an outer layer are sequentially and coaxially layered. The specifications of the inner surface layer, the outer surface layer, and the reinforcing layer are appropriately set based on the performance required for the refrigerant hose.

Patent Document 1 proposes a refrigerant hose for use in a refrigerator/freezer. In Patent Document 1, in order to improve the durability of the hose, the intermediate elongation of the reinforcing yarn forming the reinforcing layer under a load of 1.6 cN/dtex at 20° C. is specified. The reinforcing yarn is subjected to a vulcanization step when the hose is manufactured. Even if the characteristics of the unvulcanized reinforcing yarn are specified as in Patent Document 1, the characteristics of the reinforcing yarn before vulcanization and after vulcanization are different, and therefore the actual characteristics of the reinforcing yarn in the hose after vulcanization are unknown. Therefore, there is a high degree of uncertainty in having the reinforcing yarns function as intended to obtain a hose that meets the required performance. The performance required for a refrigerant hose to be used for a refrigerator with freezer is different from the performance required for a refrigerant hose to be used for an air conditioner installed in a vehicle (paragraph 0005 of Patent Document 1).

In a refrigerant hose for an air conditioner to be installed in the vehicle, a hose internal pressure of about 5 MPa to 7 MPa may repeatedly act. When the diameter of the reinforcing cord is increased in order to improve the pressure resistance of the hose, the flexibility of the hose is reduced. The refrigerant hose for an air conditioner installed in a vehicle is disposed in a narrow space and needs to have good flexibility. Therefore, there is room for improvement in the refrigerant hose for the air conditioner installed in the vehicle in order to avoid an increase in diameter of the reinforcing cord and to ensure sufficient durability even when the internal pressure of the hose of about 5 MPa or more and 7 MPa or less repeatedly applied.

### CITATION LIST

### Patent Literature

Patent Document 1: JP 2022-99711 A

### SUMMARY OF INVENTION

### Technical Problem

An object of the present invention is to provide a refrigerant hose that can have sufficient durability for practical use even when a hose internal pressure of about 5 MPa or more and 7 MPa or less repeatedly acts on the refrigerant hose while avoiding an increase in diameter of a reinforcing cord to be used for the refrigerant hose for an air conditioner installed in a vehicle and a method of manufacturing the same.

### Solution to Problem

To achieve the object described above, a refrigerant hose according to an embodiment of the present invention is a refrigerant hose through which a refrigerant of an air conditioner installed in a vehicle flows. The refrigerant hose includes: an inner surface layer and an outer surface layer coaxially layered; and a reinforcing layer composed of a reinforcing cord and coaxially layered between the inner surface layer and the outer surface layer. As the reinforcing cord, a fiber cord having an outer diameter of 0.4 mm or more and 0.6 mm or less is used. The reinforcing cord removed from the hose has elongation of 6.0% or less under a load of 1.3 cN/dtex when subjected to tensile testing at 150° C. and has strength at break of 220 N or more when subjected to tensile testing at room temperature.

A method of manufacturing a refrigerant hose according to an embodiment of the present invention is a method of manufacturing a refrigerant hose through which a refrigerant of an air conditioner installed in a vehicle flows by sequentially and coaxially layering an inner surface layer, a reinforcing layer composed of a reinforcing cord, and an outer surface layer and vulcanizing the hose molded article. The method includes:
making a plurality of specifications of a fiber cord having an outer diameter of 0.4 mm or more and 0.6 mm or less different;
vulcanizing a sample of the hose molded article molded by using the fiber cord of each of the specifications, then performing tensile testing on each fiber cord removed from the sample at 150° C. to grasp a relationship between a tensile load and elongation in advance and performing tensile testing on each fiber cord at room temperature to grasp strength at break;
based on respective standard values of elongation under a load of 1.3 cN/dtex at 150° C. and strength at break at room temperature that are required for the reinforcing cord of the refrigerant hose and based on the relationship grasped in advance and the strength at break, determining a specification of the fiber cord before vulcanization that satisfies the respective standard values; and
molding the hose molded article by using, as the reinforcing cord, the fiber cord having the specification determined.

### Advantageous Effects of Invention

The refrigerant hose of an embodiment of the present invention allows, by using the fiber cord having an outer diameter of 0.4 mm or more and 0.6 mm or less as the reinforcing cord, an increase in diameter of the reinforcing cord to be avoided. Accordingly, the refrigerant hose having good flexibility is obtained. When the reinforcing cord removed from the hose manufactured by vulcanization is subjected to the tensile testing at 150° C., the elongation at the load of 1.3 cN/dtex is 6.0% or less, and when the tensile testing is performed thereon at room temperature, the strength at break is 220 N or more. Therefore, the refrigerant hose capable of ensuring practically sufficient durability even when the hose internal pressure of about 5 MPa or more and 7 MPa or less is repeatedly applied is obtained.

In the method of manufacturing a refrigerant hose of the present invention, using the fiber cord having an outer diameter of 0.4 mm or more and 0.6 mm or less as the reinforcing cord allows an increase in diameter of the reinforcing cord to be avoided. Based on respective standard values of elongation under a load of 1.3 cN/dtex at 150° C. and strength at break at room temperature that are required for the reinforcing cord of the refrigerant hose and based on the relationship grasped in advance and strength at break, a specification of the fiber cord before vulcanization that satisfies the respective standard values is determined. Therefore, setting the respective standard values to elongation of 6.0% or less and strength at break of 220 N or more allows for grasping the specification of the fiber cord having characteristics of the reinforcing cord removed from the hose manufactured by vulcanization having the elongation of 6.0% or less under the load of 1.3 cN/dtex when subjected to the tensile testing at 150° C., and having the strength at break of 220 N or more when subjected to the tensile testing at room temperature. Therefore, vulcanizing the hose molded article molded by using the fiber cord having the grasped specification as the reinforcing cord can obtain a refrigerant hose that can ensure sufficient durability for practical use even when the hose internal pressure of about the 5 MPa or more and the 7 MPa or less is repeatedly applied.

### BRIEF DESCRIPTION OF DRAWINGS

FIG. 1 is an explanatory diagram illustrating a partial cutout of an embodiment of a refrigerant hose according to the present invention.

FIG. 2 is an explanatory diagram illustrating the cross-sectional structure of the hose of FIG. 1.

FIG. 3 is an explanatory diagram illustrating a partial cutout of a hose molded article.

FIG. 4 is an explanatory diagram illustrating a vulcanization step for the hose molded article.

FIG. 5 is a graph illustrating results of tensile tests of a fiber cord removed from a sample of the vulcanized hose molded article at 150° C.

### DESCRIPTION OF EMBODIMENTS

A refrigerant hose and a method of manufacturing the refrigerant hose according to embodiments of the present invention will be described below with reference to the drawing.

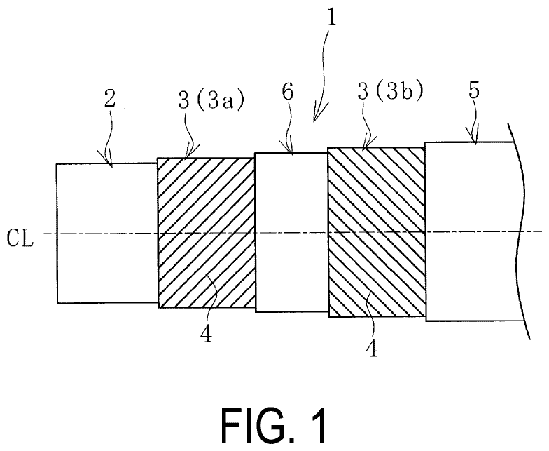

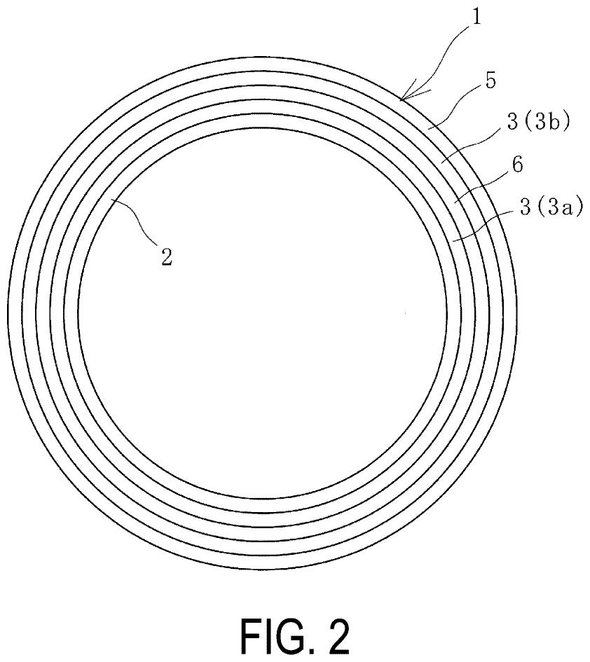

As illustrated in FIGS. 1 and 2, a refrigerant hose 1 (hereafter referred to as a hose 1) according to an embodiment is configured such that an inner layer 2, a reinforcing layer 3, and an outer layer 5 are coaxially layered in this order. In this embodiment, the reinforcing layer 3 has a two-layer structure in which a first reinforcing layer 3a and a second reinforcing layer 3b are coaxially layered, and an intermediate rubber layer 6 is interposed between the first reinforcing layer 3a and the second reinforcing layer 3b. Note that a dot-dash line CL in the drawings represents a hose axial center.

A refrigerant C of an air conditioner installed in various vehicles such as a passenger vehicle, a truck, a bus, and a construction vehicle flows through the hose 1. Examples of the refrigerant C include HFC-134a and HFO-1234y.

The refrigerant C directly contacts the inner surface layer 2. Therefore, an appropriate material (such as resin or rubber) is employed for the inner surface layer 2 in consideration of durability and the like against the refrigerant C, and a blended material of a polyamide (PA) and a rubber-based material, for example, is used. In a configuration in which HFO-1234y is used as the refrigerant C, impermeable properties against the refrigerant C can be improved by using a nylon-based resin for the inner surface layer 2. The layer thickness of the inner surface layer 2 is, for example, 0.5 mm or more and 2.5 mm or less. The inner diameter of the inner surface layer 2 (that is, the inner diameter of the hose 1) is, for example, 11 mm or more and 13 mm or less. The inner surface layer 2 is not limited to a single-layer structure but may be a multilayer structure. For example, the inner surface layer 2 may have, from the inner circumferential side toward the outer circumferential side, a multilayer structure of a resin layer and a rubber layer, a multilayer structure of a rubber layer and a resin layer, a multilayer structure of different types of resins, a multilayer structure of different types of rubber layers, or a structure obtained by appropriately combining these structures.

The outer surface layer 5 is made of an appropriate material depending on the performance required for the hose 1, and examples of the material include various rubbers such as CR rubber, EPDM rubber, and SBR rubber, and various resins. The layer thickness of the outer surface layer 5 is, for example, 0.5 mm or more and 2.5 mm or less.

The reinforcing layer 3 is formed by a reinforcing cord 4. In this embodiment, the first reinforcing layer 3a is formed by helically winding the reinforcing cord 4 around the hose axial center CL, and the second reinforcing layer 3b is formed by helically winding the reinforcing cord 4 in a direction opposite to the direction of the reinforcing cord 4 of the first reinforcing layer 3a. The winding density (braiding density) of the reinforcing cord 4 is preferably 95% or more. When the winding density (braiding density) is 100%, the reinforcing cord 4 is wound without a gap.

The reinforcing layer 3 is not limited to the spiral structure as in this embodiment, and may have a braid structure in which the reinforcing cords 4 are braided at a predetermined angle with respect to the hose axial center CL. The number of layers of the reinforcing layer 3 having the spiral structure is two (a plurality of layers), but the number of layers of the reinforcing layer 3 having the blade structure is not limited to two (a plurality of layers) and may be one.

As the reinforcing cord 4, a fiber cord having an outer diameter of 0.4 mm or more and 0.6 mm or less is used. Specifically, a resin fiber cord such as a polyester fiber cord is used as the reinforcing cord 4. The reinforcing cord 4 has, for example, a specification (single twist structure) formed by twisting three or more and four or less filaments made of polyester. The reinforcing cord 4 is formed by primarily twisting three or more and four or less filaments. Forming the reinforcing cord 4 by twisting the three or more and four or less filaments is advantageous in improving strength at break without impairing fatigue resistance of the reinforcing cord 4.

For example, a twist coefficient K of the reinforcing cord 4 calculated by the following formula (1) is set to 250 or more and 400 or less.

$$Twist coefficient K = T \times {D}^{1 / 2} \qquad ( 1 )$$

Here, T is a lower twist count of the reinforcing cord 4 (counts/10 cm) and D is a total fineness of the reinforcing cord 4 (dtex).

The intermediate rubber layer 6 firmly joins the first reinforcing layer 3a and the second reinforcing layer 3b that are layered adjacent to each other, and functions as a cushioning material that avoids wear due to contact between the respective reinforcing cords 4. The intermediate rubber layer 6 may be of a known specification used for hose manufacturing. The intermediate rubber layer 6 may be omitted.

Further, in this embodiment, the tensile properties of the reinforcing cord 4 removed from the hose 1 before use are specified. Since the hose 1 is manufactured through a vulcanization step, the reinforcing cord 4 removed from the hose 1 has been through the vulcanization step.

The tensile properties of the reinforcing cord 4 will be described in detail. When the reinforcing cord 4 removed from the hose 1 before use is subjected to tensile testing at 150° C., the elongation under a load of 1.3 cN/dtex is 6.0% or less, and when the tensile testing is performed at room temperature (20° C. or more and 25° C. or less), the strength at break is 220 N or more. This tensile testing is performed in accordance with JIS L1017:2002. The relationship between the tensile load and the elongation of the fiber cord of each specification is measured by this tensile testing, and an elongation E1 under 1.3 cN/dtex is calculated from the measurement data. It is more preferable that the elongation E1 under a load of 1.3 cN/dtex is 5.0% or less and the strength at break is 260 N or more when the above-described tensile testing is performed.

In general, the fiber cord shrinks by heating in the vulcanization step. Therefore, the elongation E1 under 1.3 cN/dtex after vulcanization of the same fiber cord is often larger than the elongation under 1.3 cN/dtex before vulcanization. However, since the degree of change in the tensile properties before and after vulcanization differs depending on the specifications of the fiber cord, the degree of change cannot be determined unless the fiber cord of each specification is actually measured.

When the internal pressure of the hose is about 5 MPa or more and 7 MPa or less, the tensile load acting on the reinforcing cord 4 is about 1.3 cN/dtex. In this embodiment, a standard value Ce (6.0% or less) of the elongation E1 of the reinforcing cord 4 under a load of 1.3 cN/dtex at 150° C. is specified in consideration of high-temperature use environments such as an engine room where the hose 1 is installed. A standard value Cf (220 N or more) of the strength at break of the reinforcing cord 4 at room temperature (20° C. or more and 25° C. or less) has been specified from various findings so far. Therefore, the reinforcing cord 4 used for the hose 1 satisfies the respective standard values Ce and Cf.

As long as the reinforcing cord 4 satisfies the above-described tensile properties (standard values Ce and Cf), for example, polyethylene terephthalate (PET) fiber, polyethylene naphthalate (PEN) fiber, aramid fiber, polyparaphenylene benzoxazole (PBO) fiber, 66 nylon fiber, and the like can be used in addition to the polyester fiber.

Next, an example of a procedure for manufacturing the hose 1 by the method of manufacturing the hose according to the present invention will be described.

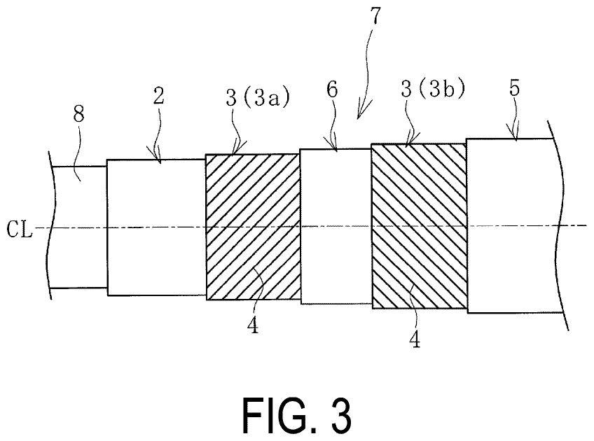

First, the specification of the reinforcing cord 4 used for the hose 1 is determined. Then, a fiber cord is used as the reinforcing cord 4, and the specifications of the reinforcing cords 4 having an outer diameter of 0.4 mm or more and 0.6 mm or less are made different, and samples of a hose molded article 7 illustrated in FIG. 3 are molded by a known method using the reinforcing cord 4 having each of the specifications.

For example, the specifications of the reinforcing cord 4 are made different by making at least one of the outer diameter of the reinforcing cord 4, the number of filaments, the twist count of the filaments, and the material of the filaments different. The specification of the reinforcing cord 4 also can be made different by adjusting at least one of the heating temperature of heat treatment of the reinforcing cord 4 using a known method, the magnitude of tension, and speed (time) of the heat treatment. Alternatively, a plurality of these may be combined to make the specifications of the reinforcing cord 4 different.

Next, the sample of the hose molded article 7 using the reinforcing cord 4 of the respective specifications is vulcanized to manufacture samples of the hose 1. As illustrated in FIG. 3, when the sample of the hose 1 is manufactured, a rod-like mandrel 8 is used as a core material, and members constituting the inner surface layer 2, the first reinforcing layer 3a, the intermediate rubber layer 6, the second reinforcing layer 3b, and the outer surface layer 5 are sequentially layered on the outer circumferential side of the mandrel 8 by a known method, thereby molding the sample of the hose molded article 7 on the outer circumferential surface of the mandrel 8. In molding the first reinforcing layer 3a and the second reinforcing layer 3b, the prepared reinforcing cords 4 having the respective specifications are wound helically around the hose axial center CL.

Next, in vulcanizing the sample of the hose molded article 7, a covering material 9 functioning as an outer mold is layered on the outermost circumferential surface of the sample of the hose molded article 7, and the entire length of the sample of the hose molded article 7 is covered with the covering material 9. The covering material 9 is a known material used for hose manufacturing, and is formed of polymethylpentene, 11 nylon, or the like.

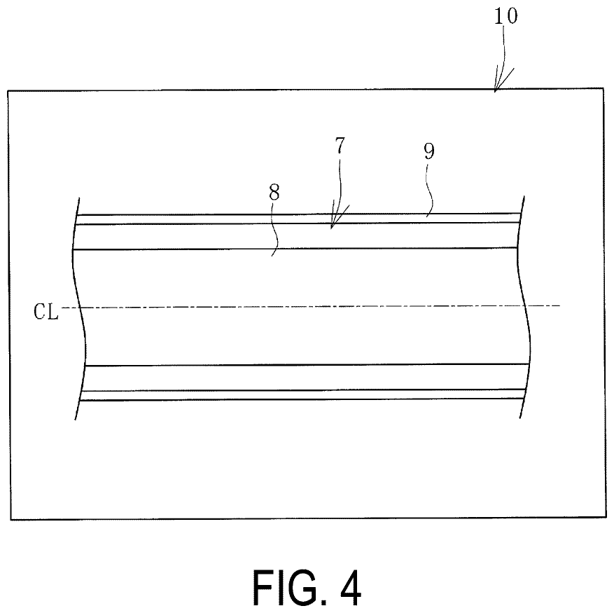

Next, as illustrated in FIG. 4, the sample of the hose molded article 7 covered with the covering material 9 is disposed inside a vulcanization device 10 together with the mandrel 8. As the vulcanization device 10, known equipment used for hose manufacturing such as a vulcanization box may be used. The sample of the hose molded article 7 is vulcanized for a predetermined time by the vulcanization device 10, whereby the sample of the hose 1 is manufactured. After the vulcanization step has been completed, the mandrel 8 is pulled out of the sample of the hose 1 and the covering material 9 is removed from the sample of the hose 1.

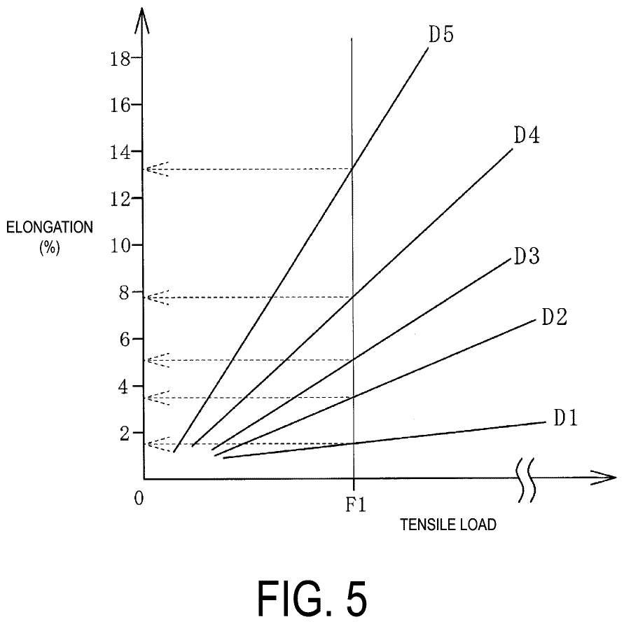

Then, the reinforcing cord 4 is removed from the manufactured sample of the hose 1. The tensile testing is performed on the removed reinforcing cord 4 of each specification under conditions of 150° C. and room temperature (20° C. or more and 25° C. or less). The tensile testing is performed in accordance with JIS L1017:2002 described above. The data illustrated in FIG. 5 is obtained by the tensile testing under the condition of 150° C. Data D1 to D5 illustrated in FIG. 5 indicate the relationship between the tensile load and the elongation (elongation ratio %) of the reinforcing cord 4 of each specification, and this relationship is grasped in advance by performing the tensile tests. The strength at break (data Dt1 to Dt5) of the reinforcing cord 4 of each specification is grasped in advance by the tensile testing under a room-temperature condition. The tensile testing under each of the conditions of 150° C. and room temperature uses different samples and does not use the same sample. That is, a sample that has been subjected to the tensile testing under the condition of 150° C. is not used for the tensile testing under the condition of room temperature. FIG. 5 illustrates the data D1 to D5 for five types of reinforcing cords 4 with different specifications, but it is preferable to obtain tensile test data for the reinforcing cords 4 with more types of specifications (for example, 10 types or more).

Since the fineness of each reinforcing cord 4 is known, a tensile load F1 applied to each reinforcing cord 4 when a tensile load of 1.3 cN/dtex is applied to each reinforcing cord 4 can be calculated. Therefore, using the data D1 to D5, the elongation (elongation rate) % of each reinforcing cord 4 when this tensile load F1 is applied (that is, when the load of 1.3 cN/dtex is applied) is grasped. In FIG. 5, the five types of reinforcing cords 4 are described as having the same fineness.

In the data D1 to D5 illustrated in FIG. 5, the elongation when the tensile load F1 is applied to each reinforcing cord 4 (that is, when the load of 1.3 cN/dtex is applied) is about 1.5%, about 3.3%, about 5.2%, about 7.8%, and about 13.2% as indicated by dashed line arrows. Therefore, when the standard value Ce of the elongation under the load of 1.3 cN/dtex at 150° C. is 6.0% or less, the specifications of the reinforcing cord 4 corresponding to the data D1, D2, and D3 satisfy the standard value Ce. When the standard value Ce is 5.0% or less, the specifications of the reinforcing cords 4 corresponding to the data D1 and D2 satisfy the standard value Ce. In this manner, the specifications of the reinforcing cord 4 that satisfy the desired standard value Ce can be grasped by using the data D1 to D5.

When the standard value Cf of the strength at break of the reinforcing cord 4 at room temperature is 220 N or more, the specifications of the reinforcing cord 4 that satisfy the standard value Cf can be grasped from the data Dt1 to Dt5 grasped in advance. In this manner, the specifications of the reinforcing cord 4 that satisfy the desired standard value Cf can be grasped by using the data Dt1 to Dt5.

As described above, based on the respective standard values Ce and Cf of the elongation under the load of 1.3 cN/dtex at 150° C. and the strength at break at room temperature that are required for the reinforcing cord 4 of the hose 1, and the relationships between the tensile load and the elongation (data D1 to D5) of the reinforcing cord 4 with each specification that are grasped in advance and illustrated in FIG. 5 and the strength at break (data Dt1 to Dt5), the specifications of the reinforcing cord 4 before vulcanization that satisfy the respective standard values Ce and Cf are determined.

In manufacturing the hose 1, the hose molded article 7 illustrated in FIG. 3 is molded by using the reinforcing cord 4 having the above-described determined specification. Next, by placing the hose molded article 7 inside the vulcanization device 10 as illustrated in FIG. 4 and vulcanizing the hose molded article 7, the hose 1 is manufactured. The procedure for manufacturing the hose 1 is the same as the procedure for manufacturing the sample of the hose 1 described above.

In the hose 1 and the method of manufacturing the hose 1, the fiber cord having an outer diameter of 0.4 mm or more and 0.6 mm or less is used as the reinforcing cord 4, allowing for avoiding an increase in diameter of the reinforcing cord 4. Therefore, it is advantageous for ensuring good flexibility of the hose 1, and the hose 1 is easily disposed in a narrow engine room of a vehicle. In addition, avoiding an increase in diameter of the reinforcing cord 4 is advantageous for improving workability and reducing weight in manufacturing the hose 1.

In the hose 1, when the reinforcing cord removed from the hose 1 manufactured by vulcanization is subjected to the tensile testing under the condition of 150° C., the elongation under the load of 1.3 cN/dtex is 6.0% or less, and when the tensile testing is performed under the condition of room temperature, the strength at break is 220 N or more. Therefore, even if the internal pressure of about 5 MPa or more and 7 MPa or less is repeatedly applied to the hose 1, expansion of the hose 1 is suppressed, and durability sufficient for practical use can be ensured.

In the method of manufacturing the hose 1, as described above, specifications of the unvulcanized reinforcing cord 4 that satisfy the standard values Ce and Cf are determined, allowing for grasping the specifications of the reinforcing cord 4 having the elongation under the load of 1.3 cN/dtex is 6.0% or less when the reinforcing cord 4 removed from the hose 1 manufactured by vulcanization is subjected to the tensile testing under the condition of 150° C. and having the strength at break is 220 N or more when the tensile testing is performed under the condition of room temperature. Therefore, vulcanizing the hose molded article 7 molded by using the reinforcing cord 4 having the specifications satisfying the standard values Ce and Cf can obtain a hose that can have practically sufficient durability even when the hose internal pressure of about 5 MPa or more and 7 MPa or less is repeatedly applied.

### Example

A total of 11 types of Conventional Example, Examples 1 to 5, and Comparative Examples 1 to 5 were prepared by differentiating specifications of reinforcing cords (single twist structure) formed by twisting four filaments made of polyester as shown in Table 1. The above-described twist coefficient K of these 11 types of reinforcing cords was in a range of 250 or more and 400 or less. Hoses having the structures illustrated in FIGS. 1 and 2 were manufactured using each reinforcing cord. The hoses thus manufactured are different from each other only in the specification of the reinforcing cord, and the other members and the vulcanization conditions are the same.

The reinforcing cords were removed from each of the manufactured hoses, and tensile tests were performed in accordance with JIS L1017:2002 under the conditions of 150° C. and room temperature. The elongation E1 under 1.3 cN/dtex was calculated from the measurement data in the tensile test under the condition of 150° C. The test results are as shown in Table 1. The strength at break measured by the tensile test under the condition of room temperature is as shown in Table 1.

Each of the manufactured hoses were subjected to the following measurement of the amount of hose expansion under pressure and impulse durability test. The workability in the manufacture of each hose was evaluated.

### [Amount of Hose Expansion Under Pressure Measurement Test]

A hose internal pressure of 7.0 MPa was applied to each hose in an atmosphere of 150° C. and held for 30 seconds, the pressure was released, 30 seconds after the pressure was released, the internal volume of each hose was measured, and an increase in internal volume of the hose compared to the internal volume of the hose before the hose internal pressure was applied was calculated. The increase in the internal volume per unit length of the hose is shown in Table 1 as the amount of expansion. The smaller the value of the expansion amount, the more the expansion of the hose due to the hose internal pressure is suppressed, and the more excellent the pressure resistance is.

### [Impulse Durability Test]

The durability of each hose was evaluated by repeatedly maintaining the hose internal pressure at 0 MPa for one second and then at 7.0 MPa for one second in an atmosphere of 150° C. That is, the hose internal pressure of 0 MPa and 7.0 MPa were repeatedly loaded with a rectangular wave at a cycle of 0.5 Hz, and the number of times of loading (the number of cycles) at which the hose was damaged was measured. In Table 1, the case where the hose was damaged when the number of times of loading was less than 450,000 times is indicated by x, the case where the hose was damaged when the number of times of loading was 450,000 times or more and less than 600,000 times is indicated by ◯, and the case where the hose was not damaged even when the number of times of loading was 600,000 times or more is indicated by ⊚.

### [Processability]

The ease of processing in the manufacture of each hose was confirmed on the manufacturing line. In Table 1, the case where the hose could be smoothly manufactured is indicated by ◯, and the case where the hose could not be smoothly manufactured is indicated by x. In Comparative Example 5, the reinforcing cord was too thick to be smoothly wound helically. Therefore, an evaluable hose could not be manufactured, and the above-described evaluation of the amount of expansion and the durability could not be performed.

TABLE 1

| | | Conventional | Example | | | | | Comparative Example | | | | |
|---|---|---|---|---|---|---|---|---|---|---|---|---|
| | | Example | 1 | 2 | 3 | 4 | 5 | 1 | 2 | 3 | 4 | 5 |
| Reinforcing | Cord outer | 0.49 | 0.46 | 0.47 | 0.53 | 0.42 | 0.56 | 0.48 | 0.52 | 0.55 | 0.38 | 0.63 |
| cord | diameter d | | | | | | | | | | | |
| | (mm) | | | | | | | | | | | |
| | Elongation E1 | 7.1 | 4.1 | 4.8 | 5.4 | 3.9 | 5.7 | 4.5 | 6.4 | 6.8 | 4.9 | 4.8 |
| | under 1.3 | | | | | | | | | | | |
| | cN/dtex (%) | | | | | | | | | | | |
| | Strength at | 200 | 294 | 270 | 264 | 221 | 280 | 210 | 229 | 298 | 275 | 268 |
| | break (N) | | | | | | | | | | | |
| Hose | Amount of | 51.3 | 34.8 | 38.2 | 40.6 | 31.4 | 43.2 | 34.9 | 47.7 | 49.4 | 38.5 | — |
| | expansion | | | | | | | | | | | |
| | (ml/m) | | | | | | | | | | | |
| | Durability | X | ⊚ | ⊚ | ◯ | ◯ | ◯ | X | X | X | X | — |
| | Processability | ◯ | ◯ | ◯ | ◯ | ◯ | ◯ | ◯ | ◯ | ◯ | ◯ | X |

As can be seen from the results in Table 1, in Examples 1 to 5, the amount of expansion of the hose is suppressed compared to Conventional example, and durability sufficient for practical use can be ensured. It can be seen that the workability in manufacturing the hose is good in Examples 1 to 5.

### REFERENCE SIGNS LIST

1 Refrigerant hose
2 Inner surface layer
3 Reinforcing layer
3a First reinforcing layer
3b Second reinforcing layer
4 Reinforcing cord (fiber cord)
5 Outer surface layer
6 Intermediate rubber layer
7 Hose molded article
8 Mandrel
9 Covering material
10 Vulcanization device

1. A refrigerant hose through which a refrigerant of an air conditioner installed in a vehicle flows, the refrigerant hose comprising:
an inner surface layer and an outer surface layer coaxially layered; and
a reinforcing layer composed of a reinforcing cord and coaxially layered between the inner surface layer and the outer surface layer;
as the reinforcing cord, a fiber cord having an outer diameter of 0.4 mm or more and 0.6 mm or less being used, and
the reinforcing cord removed from the hose having elongation of 6.0% or less under a load of 1.3 cN/dtex when subjected to tensile testing at 150° C. and having strength at break of 220 N or more when subjected to tensile testing at room temperature.

2. The refrigerant hose according to claim 1, wherein the reinforcing cord removed from the hose has elongation of 5.0% or less under a load of 1.3 cN/dtex when subjected to tensile testing at 150° C. and has strength at break of 260 N or more when subjected to tensile testing at room temperature.

3. The refrigerant hose according to claim 1, wherein
the reinforcing layer has a two-layer structure in which a first reinforcing layer and a second reinforcing layer are coaxially layered,
the first reinforcing layer is formed by helically winding the reinforcing cord around a hose axial center,
the second reinforcing layer is formed by helically winding the reinforcing cord in a direction opposite to the reinforcing cord of the first reinforcing layer, and
an intermediate rubber layer is interposed between the first reinforcing layer and the second reinforcing layer.

4. A method of manufacturing a refrigerant hose through which a refrigerant of an air conditioner installed in a vehicle flows by sequentially and coaxially layering an inner surface layer, a reinforcing layer composed of a reinforcing cord, and an outer surface layer to mold a hose molded article and vulcanizing the hose molded article, the method comprising:
making a plurality of specifications of a fiber cord having an outer diameter of 0.4 mm or more and 0.6 mm or less different;
vulcanizing a sample of the hose molded article molded by using the fiber cord of each of the specifications, then performing tensile testing on each fiber cord removed from the sample at 150° C. to grasp a relationship between a tensile load and elongation in advance, and performing tensile testing on each fiber cord at room temperature to grasp strength at break;
based on respective standard values of elongation under a load of 1.3 cN/dtex at 150° C. and strength at break at room temperature that are required for the reinforcing cord of the refrigerant hose and based on the relationship grasped in advance and the strength at break, determining a specification of the fiber cord before vulcanization that satisfies the respective standard values; and
molding the hose molded article by using, as the reinforcing cord, the fiber cord having the specification determined.

5. The refrigerant hose according to claim 2, wherein
the reinforcing layer has a two-layer structure in which a first reinforcing layer and a second reinforcing layer are coaxially layered,
the first reinforcing layer is formed by helically winding the reinforcing cord around a hose axial center,
the second reinforcing layer is formed by helically winding the reinforcing cord in a direction opposite to the reinforcing cord of the first reinforcing layer, and
an intermediate rubber layer is interposed between the first reinforcing layer and the second reinforcing layer.
